(19) United States
(12) Patent Application Publication
(10) Pub. No.: US 2003/0039431 A1
(43) Pub. Date: Feb. 27, 2003

(54) Coupling for optical signals

(76) Inventor: Elmar Griese, Paderborn (DE)

Correspondence Address: FISH & RICHARDSON PC, 225 FRANKLIN ST, BOSTON, MA, 02110, US

(21) Appl. No.: 10/134,040

(22) Filed: Apr. 26, 2002

(30) Foreign Application Priority Data
Apr. 27, 2001 (DE) 10120694.1

(51) Int. Cl. G02B 6/26

(52) U.S. Cl. 385/15; 385/27

(57) ABSTRACT

A coupler for optical signals includes first and second coupling surfaces. Each of the first and second coupling surfaces has an optically-active region to map a light pattern according to a predetermined mapping function onto the other of the first and second coupling surfaces. Mechanical guide elements having positions on the coupler that are based on the predetermined mapping function.

### CROSS-REFERENCE TO RELATED APPLICATION

This application claims priority to German Patent Application No. 10120694.1, filed on Apr. 27, 2001, the contents of which are hereby incorporated by reference into this application as if set forth herein in full.

### TECHNICAL FIELD

This invention relates to a coupler for optical signals and to methods for positioning mechanical guide elements on such a coupler.

### BACKGROUND

It is known that data-processing systems may be coupled to one another using optical links (e.g., optical fibers). However, optical links have not yet been introduced into electronic systems, in particular, into electronic circuits in electronic systems. This is due, in part, to the fact that optical conductors cannot be produced and connected using the same proven technology as electrical conductors.

One solution to the foregoing problem is to embed optical conductors in a printed circuit board. The problems associated with connecting the optical conductors is addressed by milling slots into the printed circuit board, close to the ends of the optical fibers, and in an additional production process, exposing the ends of the optical conductors. In this case, precision hollow cylinders are embedded alongside the optical conductors during the production process itself, and are cut through and used as guide elements. The connection is made by inserting couplers into the milled recesses. These couplers have guide pins which engage in the hollow cylinders and thus allow precise positioning. The hollow cylinders and guide pins are known for MT plug connectors for optical fiber cables to equipment or to circuits. The guide pins are normally produced to be slightly conical, so that they may have a centering effect.

EP 393 829 describes optical couplers that deflect optical signals through 90° and, hence, deflect the optical signals from a direction parallel to the surface of a printed circuit board into a direction perpendicular to the surface of the printed circuit board. Couplers such as these are inserted into the printed circuit board. Following insertion, components are placed above the couplers to emit and to receive optical signals downwards, i.e., at right angles to the board surface and toward the board surface. However, these components must be positioned with an accuracy that is an order of magnitude greater than that heretofore achieved by automatic placement machines.

### SUMMARY

The present invention is thus directed to designing optical couplers such that high precision is achieved, both for connection to the optical conductors and for connection to the components, with little complexity.

This object is achieved according to the invention by an optical coupler having features such as those specified in the claims and accompanying specification.

In general, in one aspect, the invention is a coupler for optical signals. The coupler includes first and second coupling surfaces, each of the first and second coupling surfaces having an optically-active region to map a light pattern according to a predetermined mapping function onto the other of the first and second coupling surfaces. Mechanical guide elements are included that have positions that are based on the predetermined mapping function. This aspect may include one or more of the following.

The first and second coupling surfaces may be at right angles to one another. The predetermined mapping function may provide, at least partly, a linear map of the light pattern. The optically-active region of the first and second coupling surfaces may include optical fibers. Each of the first and second surfaces may include two mechanical guide elements. A center point of each optically-active region may lie on a connecting line between center points of the mechanical guide elements. The mechanical guide elements may be at least one of sleeves and pins that are substantially cylindrical. The coupler may be substantially rectangular (e.g., cubical) in shape.

In general, in another aspect, the invention is directed to a method, for use with the foregoing optical coupler, which includes emitting light at a predetermined position onto the first coupling surface having a mechanical guide element in a predetermined positioned, measuring a position of light arriving at the second coupling surface, determining a nominal position of the mechanical guide element on the second coupling surface based on the measured position of the emerging light, and placing the mechanical guide element on the second coupling surface based on the nominal position. This aspect may include one or more of the following features.

The nominal position may be marked prior to placing the mechanical guide element. The light may be emitted using a reference emitter and the position may be measured using an optical measurement sensor. The method may include shining light onto an area of the second coupling surface, determining a position at which the light emerges at the first coupling surface, determining a light input position based on the position at which the light emerges at the first coupling surface, and positioning the guide element on the first coupling surface based on the determined light input position. The coupler may include plural optically-active regions and the nominal position may be determined based on more than two positions of light arriving at the second coupling surface via the plural optically-active regions.

This summary has been provided so that the nature of the invention can be understood quickly. A detailed description of illustrative embodiments of the invention is set forth below.

### DESCRIPTION OF THE DRAWINGS

FIG. 1 shows a view of a printed circuit board in which a coupler according to one embodiment of the invention is employed;

FIG. 2 shows a side view of the printed circuit board shown in FIG. 1 (in the direction of the arrow A of FIG. 1);

FIG. 3 shows a coupler according to one embodiment of the invention; and

FIG. 4 shows an alternative embodiment of a coupler.

### DETAILED DESCRIPTION

Optical fiber bundles may be used in an optical couplers. The bundles have an optically-active area that is considerably larger than that of the optical fibers and reproduce a pattern on an opposite surface of the optical coupler. Guide sleeves can be inserted into the optical coupler. The absolute position of the guide pins relative to the optical fiber bundles is not critical, provided that measures are taken to ensure that a wave guide or wave guides will later be located completely in front of active surfaces of the optical fiber bundles. An optical reference is connected to the optical coupler, which produces light spots on the active regions of the optical fiber bundles and in which the distances to the guide sleeves have been adjusted and/or measured accurately.

The light spots appear on the other surface of the optical coupler via the bundles. The outlet surfaces of the optical fiber bundles are determined by measurement using, e.g., electronic cameras, based on nominal positions of the guide cylinders on the outlet surface. The components to be coupled once again have guide pins which fit into the guide sleeves that have been previously inserted.

One approach is to use uniform optical fiber bundles, in which an image projected from an inlet surface onto an inlet surface appears in a congruent manner on an outlet surface. In most cases, these represent the best solution, at the same time. However, it is possible for linear distortion, i.e., expansion or extension, to occur at the same time in one or two dimensions. Long optical fiber runs in the printed circuit board can thus be compressed. The guide pins are either compressed or are mapped linearly by the same factor. In the latter case, the mapping function may be linear in places.

Nonlinear mapping functions may be used, depending on the continuity and uniqueness of the bundles. The maps should be defined in advance.

The optical couplers can be produced independently of the printed circuit boards and of the components to be coupled, can be inserted into prepared printed circuit boards, and the components of the boards can be positioned, in separate production steps. All the handling operations on the printed circuit boards can be carried out with the normal accuracy there, since the guide elements ensure the final positioning. Greater accuracy is required only for the production of the couplers, and even this is required only for the second step of insertion of the guide pins. The guide pins can be produced at the same time as the production of the couplers, i.e., the placement of the optical fiber bundles and the extrusion coating with a filling material, provided that this gives an accuracy which is better than the expansion of the optical fiber bundles.

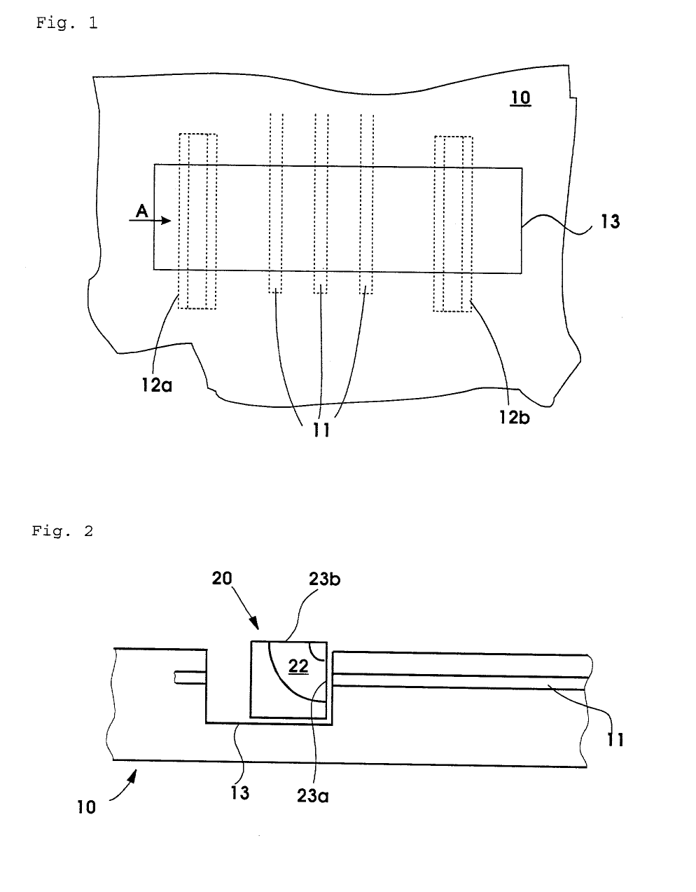

FIG. 1 shows a plan view of a printed circuit board 10 having optical conductors 11 embedded therein. Mechanical guide elements 12a, 12b, which, in this example, are hollow cylinders, are embedded in the same plane, and in the same direction as the optical conductors. The distance between the optical conductors and from the guide elements is achieved with the necessary high accuracy by, for example, inserting such elements into prepared comb structures (not shown), which are also embedded. This accuracy is a fraction of the diameter of the optical conductors.

The optical conductors 11 and the guide elements 12a, 12b are exposed after pressing of printed circuit board through a recess 13, e.g., as a result of a milling process in the direction of the arrow A. Deflecting couplers 20 are inserted into the rectangular cavity formed in this way, as is shown in FIG. 2.

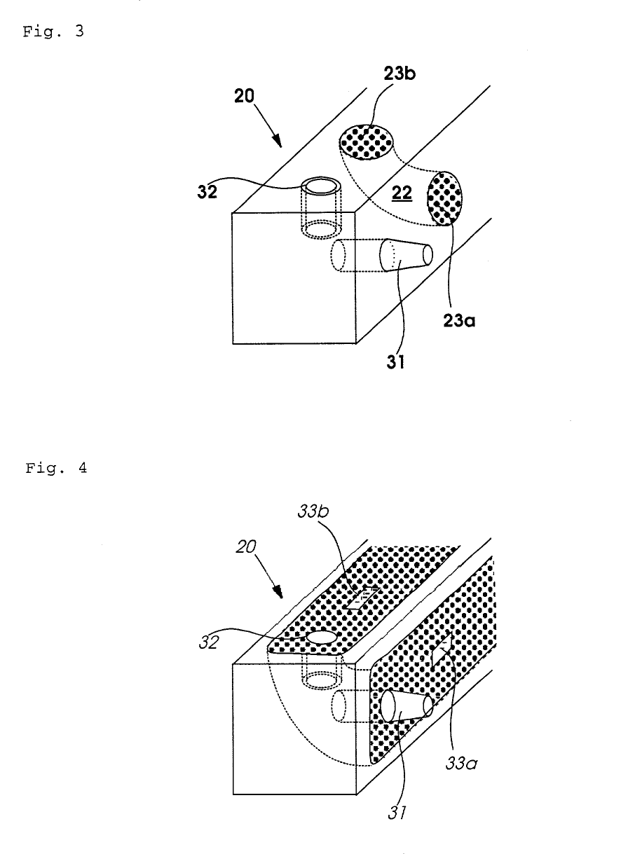

FIG. 3 shows a coupler. This coupler includes a mount 20, which is cubical in this example. Optical fiber bundles 22 are embedded in mount 20, which has inlet and outlet surfaces 23a and 23b, respectively. A number of optical fiber bundles are generally provided (not shown) in the longitudinal direction of the mount. Mechanical guide elements, in this case a pin 31 and an opening 32, are provided at the start. A second pair of mechanical guide elements (not shown) are provided at the end of the carrier 20. The two guide pins 31 form the references on one plane, while the two guide holes 32 form the reference on another plane. The center points of the inlet and outlet surfaces 23a, 23b, respectively, of the optical conductors 22 lie on the connecting line between the guide elements 31, 32, and are approximately the same distance apart from one another.

During the production process, optical fiber bundles 22 are first fixed and extrusion coated. The pins 31 are then inserted. Their separation is maintained accurately in order to achieve matching to the associated sleeves 12a, 12b located in the printed circuit board 10. The position relative to the inlet surfaces 23a of the optical conductors is not highly critical, since their cross section should not significantly exceed that of the optical conductors in the printed circuit board. The ends of the optical conductors 11 in the printed circuit board 10 should lie completely on the inlet surface 23a after insertion, in order to ensure that substantially no light energy is lost.

Additional measures are required for the production of the guide holes. For this purpose, the couplers, provided with the guide pins, are connected to a reference transmitter, with the guide pins predetermining the position. Light spots whose diameter is approximately the same as that of the fibers in the printed circuit board are then projected at an accurately predetermined distance from the guide pins onto the inlet surface 23a. This results in corresponding light spots, which are measured optically, on the outlet surfaces 23b. The light spots are transmitted via the optical bundles. The nominal position of the guide holes 32 is determined from the positions of these light spots. The holes may then be incorporated at the nominal positions using laser drills.

The embodiment shown in FIG. 4 uses a single, large optical conductor fiber bundle. The guide pins are inserted into (as shown) or alongside (not shown) the optical fiber bundle. Their position is not critical. Reference light spots 33a are now produced, as before, in a measurement device, and their corresponding light spots 33b are measured and used to determine the position of the guide sleeves. These may be drilled, in particular by lasers, with the required accuracy into the glass fiber bundles of the optical conductor, as well. Multiple bundles may also be used, in which case the positioning of the guide elements is dependent upon the locations of these multiple bundles

Other embodiments not specifically described herein are also within the scope of the following claims.

What is claimed is:

1. A coupler for optical signals, comprising:
first and second coupling surfaces, each of the first and second coupling surfaces having an optically-active region to map a light pattern according to a predetermined mapping function onto the other of the first and second coupling surfaces, and
mechanical guide elements having positions that are based on the predetermined mapping function.

2. The coupler of claim 1, wherein the first and second coupling surfaces are at right angles to one another.

3. The coupler of claim 1, wherein the predetermined mapping function provides, at least partly, a linear map of the light pattern.

4. The coupler of claim 1, wherein the optically-active region of the first and second coupling surfaces includes optical fibers.

5. The coupler of claim 1, wherein:
each of the first and second surfaces includes two mechanical guide elements; and
a center point of each optically-active regions lies on a connecting line between center points of the mechanical guide elements.

6. The coupler as claimed of claim 1, wherein the mechanical guide elements comprise at least one of sleeves and pins that are substantially cylindrical.

7. The coupler of claim 1 having a shape that is substantially cubical.

8. In a coupler for optical signals having first and second coupling surfaces, each of the first and second coupling surfaces having an optically-active region to map a light pattern according to a predetermined mapping function onto the other of the first and second coupling surfaces, and mechanical guide elements having positions that are based on the predetermined mapping function, a method of positioning the mechanical guide element on the second coupling surface, the method comprising:
emitting light at a predetermined position onto the first coupling surface having a mechanical guide element in a predetermined positioned;
measuring a position of light arriving at the second coupling surface;
determining a nominal position of the mechanical guide element on the second coupling surface based on the measured position of the emerging light; and
placing the mechanical guide element on the second coupling surface based on the nominal position

9. The method of claim 8, further comprising:
marking the nominal position prior to placing the mechanical guide element.

10. The method of claim 8, wherein the light is emitted using a reference emitter and the position is measured using an optical measurement sensor.

11. The method of claim 8, further comprising:
emitting light onto an area of the second coupling surface;
determining a position at which the light emerges at the first coupling surface;
determining a light input position based on the position at which the light emerges at the first coupling surface; and
positioning the guide element on the first coupling surface based on the determined light input position.

12. The method as claimed in claim 8, wherein:
the coupler includes plural optically-active regions; and
the nominal position is determined based on more than two positions of light arriving at the second coupling surface via the plural optically-active regions.
